(19) United States
(12) Patent Application Publication
(10) Pub. No.: US 2018/0313989 A1
(43) Pub. Date: Nov. 1, 2018

(54) POLARIZING PLATE WITH OPTICAL COMPENSATION FUNCTION

(71) Applicant: Imat Corporation, Hsinchu City (TW)

(72) Inventors: Tsai-An Yu, Hsinchu City (TW); Da-Ren Chiou, Taoyuan City (TW); Shih-Ming Hung, Hsinchu City (TW); Kuo-Chen Wu, Hsinchu City (TW); Yi-Chien Chen, Hsinchu County (TW)

(73) Assignee: Imat Corporation, Hsinchu City (TW)

(21) Appl. No.: 15/867,730

(22) Filed: Jan. 11, 2018

(30) Foreign Application Priority Data
Apr. 28, 2017 (TW) 106114200

(51) Int. Cl. G02B 5/30

(52) U.S. Cl. CPC G02B 5/3016; G02B 1/14

(57) ABSTRACT

A polarizing plate with optical compensation function is provided. The polarizing plate includes a polarizer, a liquid crystal optical compensation film, a first adhesive layer, an adhesion-promoting layer, a protective film, and a second adhesive layer. The liquid crystal optical compensation film is disposed on one side of the polarizer. The first adhesive layer is disposed between the polarizer and the liquid crystal optical compensation film. The adhesion-promoting layer is disposed between the first adhesive layer and the liquid crystal optical compensation film. The protective film is disposed on one side of the polarizer relative to the liquid crystal optical compensation film. The second adhesive layer is disposed between the polarizer and the protective film.

### CROSS-REFERENCE TO RELATED APPLICATION

This application claims the priority benefit of Taiwan application serial no. 106114200, filed on Apr. 28, 2017. The entirety of the above-mentioned patent application is hereby incorporated by reference herein and made a part of this specification.

### BACKGROUND OF THE INVENTION

### Field of the Invention

The invention relates to a polarizing plate, and more particularly, to a polarizing plate with optical compensation function.

### Description of Related Art

In general, a liquid crystal display includes two polarizing plates disposed on two sides of a liquid crystal panel. The polarizing plate can allow light in a specific direction to pass through to achieve the display function of the liquid crystal display. Currently, the polarizing plate mainly includes one polarizer, two protective films respectively located on two sides of the polarizer, and two adhesive layers used to respectively adhere the polarizer to the two protective films, wherein the two protective films are generally implemented by triacetate cellulose (TAC) films. However, using TAC films as the protective films results in a greater thickness of the polarizing plate, thus resulting in limited application under the trend of compact products. Moreover, to provide optical compensation function to the polarizing plate, currently, an optical compensation film is generally attached and fixed on the protective film via an adhesive layer, similarly, the overall thickness of the polarizing plate will be increased and lead to the limited applications for flexible displays and compact products. Therefore, the development of a thinner polarizing plate with optical compensation function is one of the current objects for those skilled in the art.

### SUMMARY OF THE INVENTION

The invention provides a polarizing plate with optical compensation function having a small thickness.

A polarizing plate with optical compensation function of the invention includes a polarizer, a liquid crystal optical compensation film, a first adhesive layer, an adhesion-promoting layer, a protective film, and a second adhesive layer. The liquid crystal optical compensation film is disposed on one side of the polarizer. The first adhesive layer is disposed between the polarizer and the liquid crystal optical compensation film. The adhesion-promoting layer is disposed between the first adhesive layer and the liquid crystal optical compensation film. The protective film is disposed on one side of the polarizer relative to the liquid crystal optical compensation film. The second adhesive layer is disposed between the polarizer and the protective film.

In an embodiment of the invention, the liquid crystal optical compensation film includes a liquid crystal broadband phase retardation film, a liquid crystal positive C plate retardation film, a liquid crystal negative C plate retardation film, a liquid crystal A plate retardation film, a liquid crystal O plate retardation film, or a liquid crystal bi-axial retardation film.

In an embodiment of the invention, the thickness of the liquid crystal optical compensation film is between 1 μm and 30 μm.

In an embodiment of the invention, the thickness of the first adhesive layer is between 5 nm and 25 μm.

In an embodiment of the invention, the thickness of the adhesion-promoting layer is between 5 nm and 1000 nm.

In an embodiment of the invention, the polarizing plate with optical compensation function further includes a third adhesive layer disposed on one side of the liquid crystal optical compensation film, wherein the liquid crystal optical compensation film is between the first adhesive layer and the third adhesive layer.

In an embodiment of the invention, the liquid crystal optical compensation film is adhered to the polarizer via the first adhesive layer and the adhesion-promoting layer.

In an embodiment of the invention, the liquid crystal optical compensation film is used to protect the polarizer.

Based on the above, the polarizing plate with optical compensation function of the invention includes a polarizer, a liquid crystal optical compensation film, a first adhesive layer, an adhesion-promoting layer, a protective film, and a second adhesive layer, wherein the liquid crystal optical compensation film is disposed on one side of the polarizer, the first adhesive layer is disposed between the polarizer and the liquid crystal optical compensation film, the adhesion-promoting layer is disposed between the first adhesive layer and the liquid crystal optical compensation film, the protective film is disposed on one side of the polarizer relative to the liquid crystal optical compensation film, and the second adhesive layer is disposed between the polarizer and the protective film, such that compared to a known polarizing plate with optical compensation function including a polarizer, two protective films respectively located on two sides of the polarizer, two adhesive layers for respectively adhering the polarizer and the two protective films, an optical compensation film, and an adhesive layer for adhering the protective film and the optical compensation film, the overall thickness of the polarizing plate with optical compensation function of the invention is smaller.

In order to make the aforementioned features and advantages of the disclosure more comprehensible, embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a cross-sectional schematic diagram of a polarizing plate according to an embodiment of the invention.

### DESCRIPTION OF THE EMBODIMENTS

In the present specification, a range represented by “a numerical value to another numerical value” is a schematic representation for avoiding listing all of the numerical values in the range in the specification. Therefore, the recitation of a specific numerical range covers any numerical value in the numerical range and a smaller numerical range defined by any numerical value in the numerical range, as is the case with the any numerical value and the smaller numerical range stated explicitly in the specification.

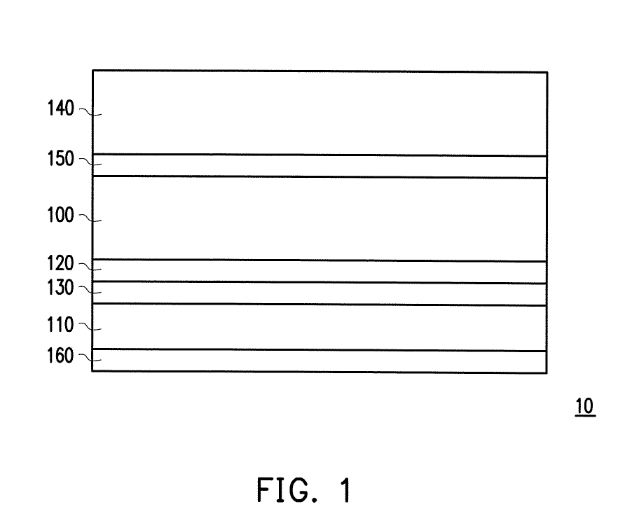

To provide a polarizing plate with a small thickness, the invention provides a polarizing plate with optical compensation function that can achieve the above advantage. In the following, an embodiment with reference to FIG. 1 is provided as an example of actual implementation of the invention.

FIG. 1 is a cross-sectional schematic diagram of a polarizing plate according to an embodiment of the invention. Referring to FIG. 1, a polarizing plate 10 includes a polarizer 100, a liquid crystal optical compensation film 110, an adhesive layer 120, an adhesion-promoting layer 130, a protective film 140, and an adhesive layer 150. Moreover, in the present embodiment, the polarizing plate 10 can further include an adhesive layer 160.

In the present embodiment, the polarizer 100 can be any polarizer known to those having ordinary skill in the art, and the polarizer 100 can be made by any method known to those having ordinary skill in the art. For instance, the polarizer 100 can, for instance, be made by the following steps: dyeing a polyvinyl alcohol film using a dichroic substance such as iodine dye and then stretching the dyed polyvinyl alcohol film in a predetermined direction. From another perspective, the polarizer 100 can, for instance, be implemented by a polyvinyl alcohol film with adsorbed dichroic dye. The thickness of the polarizer 100 is, for instance, between 5 μm and 50 μm.

The liquid crystal optical compensation film 110 is disposed on one side of the polarizer 100. The liquid crystal optical compensation film 110 can be any liquid crystal optical compensation film known to those having ordinary skill in the art. Specifically, examples of the liquid crystal optical compensation film 110 can include (but not limited to): a liquid crystal broadband phase retardation film, a liquid crystal positive C plate retardation film, a liquid crystal negative C plate retardation film, a liquid crystal A plate retardation film, a liquid crystal O plate retardation film, a liquid crystal bi-axial retardation film, or a combination thereof. In an embodiment, when the liquid crystal optical compensation film 110 is implemented by a liquid crystal broadband phase retardation film, the liquid crystal broadband phase retardation film can include two phase retardation films stacked on each other, wherein an in-plane phase difference Ro of one of the two phase retardation films is between 70 nm and 130 nm, the in-plane phase difference Ro of the other is between 140 nm and 260 nm, the included angle between the optical axes of the two phase retardation films is between 35° and 70°, and the material of the two phase retardation films can respectively include discotic liquid crystals, rod-like liquid crystals, or rod-like liquid crystals doped with chiral molecules, wherein the amount of the chiral molecules is 0.01% to 3% of the solid content.

In the present embodiment, the liquid crystal optical compensation film 110 can be used to protect the polarizer 100. In other words, in the present embodiment, in addition to providing optical compensation function, the liquid crystal optical compensation film 110 can also provide the function of the protective film 140 (details are provided below). As a result, for the polarizing plate 10, the liquid crystal optical compensation film 110 is a built-in optical compensation film. Moreover, in the present embodiment, the thickness of the liquid crystal optical compensation film 110 is, for instance, between 1 μm and 30 μm.

The adhesive layer 120 is disposed between the polarizer 100 and the liquid crystal optical compensation film 110. Specifically, in the present embodiment, the adhesive layer 120 and the polarizer 100 are in direct contact. It should be mentioned that, the polarizer 100 is generally hydrophilic, and therefore considering the adhesion between the polarizer 100 and the adhesive layer 120, the adhesive layer 120 can be implemented by a hydrophilic adhesive layer to provide good adhesion between the polarizer 100 and the adhesive layer 120. In the present embodiment, the material of the adhesive layer 120 can include (but not limited to): a liquid optically clear adhesive (LOCA), a pressure sensitive adhesive (PSA), a hydrogel, or a UV adhesive. Moreover, in the present embodiment, the thickness of the adhesive layer 120 is, for instance, between 5 nm and 25 μm.

The adhesion-promoting layer 130 is disposed between the adhesive layer 120 and the liquid crystal optical compensation film 110. Specifically, in the present embodiment, the adhesive layer 120 and the liquid crystal optical compensation film 110 are both in direct contact with the adhesion-promoting layer 130. More specifically, in the present embodiment, the adhesion-promoting layer 130 can be adhered to both the liquid crystal optical compensation film 110 and the adhesive layer 120 well. In other words, the adhesion-promoting layer 130 can provide a better bonding relationship between the liquid crystal optical compensation film 110 and the polarizer 100 such that the liquid crystal optical compensation film 110 is adhered to the polarizer 100 via the adhesive layer 120 and the adhesion-promoting layer 130. As a result, by including the adhesion-promoting layer 130 disposed between the adhesive layer 120 and the liquid crystal optical compensation film 110, the polarizing plate 10 can have optical compensation function and good structural stability. It should be mentioned that, the liquid crystal optical compensation film 110 is generally hydrophobic, and as described above, to provide good adhesion between the polarizer 100 and the adhesive layer 120, the adhesive layer 120 is generally implemented by a hydrophilic adhesive layer, and therefore the adhesion-promoting layer 130 can have the function of good adhesion with both a hydrophobic surface and a hydrophilic surface.

In the present embodiment, the material of the adhesion-promoting layer 130 is not particularly limited as long as the adhesion-promoting layer 130 can have good adhesion with both the liquid crystal optical compensation film 110 and the adhesive layer 120. Moreover, in the present embodiment, the thickness of the adhesion-promoting layer 130 is between 5 nm and 1000 nm.

The protective film 140 is disposed on one side of the polarizer 100 relative to the liquid crystal optical compensation film 110 to protect the polarizer 100. In other words, the polarizer 100 is disposed between the protective film 140 and the liquid crystal optical compensation film 110. In the present embodiment, the protective film 140 can be any protective film known to those having ordinary skill in the art applied in a polarizing plate. Specifically, the material of the protective film 140 can include (but not limited to): cellulose triacetate (TAC), cyclic olefin polymer (COP), polymethylmethacrylate (PMMA), polycarbonate (PC), acrylic or polyethylene terephthalate (PET). Moreover, in the present embodiment, the thickness of the protective film 140 is, for instance, between 20 μm and 80 μm.

The adhesive layer 150 is disposed between the polarizer 100 and the protective film 140. In other words, the protective film 140 and the polarizer 100 are adhered to each other via the adhesive layer 150. The adhesive layer 150 can be any adhesive layer known to those having ordinary skill in the art for adhering a protective layer to a polarizer.

It should be mentioned that, in the present embodiment, by including t liquid crystal optical compensation film 110, the adhesion-promoting layer 130, the adhesive layer 120, the polarizer 100, the adhesive layer 150, and the protective film 140 stacked in order, the polarizing plate 10 has a smaller thickness compared to a known polarizing plate with optical compensation function including a polarizer, two protective films respectively located on two sides of the polarizer, two adhesive layers for respectively adhering the polarizer and the two protective films, an optical compensation film, and an adhesive layer for adhering the protective film and the optical compensation film. This is because compared to a known polarizing plate with optical compensation function, the polarizing plate 10 omits the protective film located on one side and the adhesive layer for adhering the protective film and the optical compensation film and instead has one adhesion-promoting layer 130.

As described above, the liquid crystal optical compensation film 110 can have the function of optical compensation and the function of protecting the polarizer 100 similar to the protective film 140, and therefore not only can the overall thickness of the polarizing plate 10 including the liquid crystal optical compensation film 110, the adhesion-promoting layer 130, the adhesive layer 120, the polarizer 100, the adhesive layer 150, and the protective film 140 stacked in order be reduced, the manufacture thereof can also be compatible with current processes.

Moreover, as described above, the adhesion-promoting layer 130 can have good adhesion with both the liquid crystal optical compensation film 110 and the adhesive layer 120, and therefore the polarizing plate 10 including the liquid crystal optical compensation film 110, the adhesion-promoting layer 130, the adhesive layer 120, the polarizer 100, the adhesive layer 150, and the protective film 140 stacked in order can have good structural stability and good industrial applicability as a result, such as the application in an optical display.

To adhere the polarizing plate 10 to other external elements, the polarizing plate 10 can further include an adhesive layer 160 disposed on one side of the liquid crystal optical compensation film 110, wherein the liquid crystal optical compensation film 110 is between the adhesive layer 120 and the adhesive layer 160. For instance, in an embodiment, when the polarizing plate 10 is applied in an optical display, the polarizing plate 10 can be adhered on a substrate in the optical display panel via the adhesive layer 160. The adhesive layer 160 can be any adhesive layer known to those having ordinary skill in the art for adhering a polarizing plate to other external elements. Specifically, the material of the adhesive layer 160 can include (but not limited to): liquid optically clear adhesive (LOCA), an optically clear adhesive (OCA), a pressure sensitive adhesive (PSA), or a UV adhesive. Moreover, in the present embodiment, the thickness of the adhesive layer 160 is, for instance, between 5 μm and 50 μm.

It should be mentioned that, as described above, by including the liquid crystal optical compensation film 110, the adhesion-promoting layer 130, the adhesive layer 120, the polarizer 100, the adhesive layer 150, and the protective film 140 stacked in order, compared to a known polarizing plate, the polarizing plate 10 has a smaller thickness, and therefore when applied in an optical display, the demand for a thin product can be met. Moreover, as described above, the polarizing plate 10 has good structural stability, and therefore when applied in an optical display, product quality can be ensured.

Specifically, a tensile test was performed on the polarizing plate 100 with optical compensation function of the invention using a tensile testing machine (test bench model: MX2-500N, tensile tester model: ZTS-50N, manufacturer: IMADA) according to the specifications of ASTM D638, wherein the polarizing plate 100 for tensile testing includes the adhesive layer 160, the liquid crystal optical compensation film 110, the adhesion-promoting layer 130, the adhesive layer 120, the polarizer 100, the adhesive layer 150, and the protective film 140 stacked in order, and the adhesive layer 160 is adhered to a steel plate of the test bench. When the interface of the adhesive layer 160 and the steel plate starts to peel off, the tensile value is between 1.4 kg and 2.4 kg, indicating the interface bonding strength between each layer in the polarizing plate 100 of the invention is at least greater than 1.4 kg. Accordingly, the polarizing plate 100 of the invention not only has a small thickness, but also has good structural stability and industrial applicability.

Although the invention has been described with reference to the above embodiments, it will be apparent to one of ordinary skill in the art that modifications to the described embodiments may be made without departing from the spirit of the invention. Accordingly, the scope of the invention is defined by the attached claims not by the above detailed descriptions.

What is claimed is:

1. A polarizing plate with optical compensation function, comprising:
a polarizer;
a liquid crystal optical compensation film disposed on one side of the polarizer;
a first adhesive layer disposed between the polarizer and the liquid crystal optical compensation film;
an adhesion-promoting layer disposed between the first adhesive layer and the liquid crystal optical compensation film;
a protective film disposed on one side of the polarizer relative to the liquid crystal optical compensation film; and
a second adhesive layer disposed between the polarizer and the protective film.

2. The polarizing plate with optical compensation function of claim 1, wherein the liquid crystal optical compensation film comprises a liquid crystal broadband phase retardation film, a liquid crystal positive C plate retardation film, a liquid crystal negative C plate retardation film, a liquid crystal A plate retardation film, a liquid crystal O plate retardation film, or a liquid crystal bi-axial retardation film.

3. The polarizing plate with optical compensation function of claim 1, wherein a thickness of the liquid crystal optical compensation film is between 1 μm and 30 μm.

4. The polarizing plate with optical compensation function of claim 1, wherein a thickness of the first adhesive layer is between 5 nm and 25 μm.

5. The polarizing plate with optical compensation function of claim 1, wherein a thickness of the adhesion-promoting layer is between 5 nm and 1000 nm.

6. The polarizing plate with optical compensation function of claim 1, further comprising a third adhesive layer disposed on one side of the liquid crystal optical compensation film, wherein the liquid crystal optical compensation film is between the first adhesive layer and the third adhesive layer.

7. The polarizing plate with optical compensation function of claim 1, wherein the liquid crystal optical compensation film is adhered to the polarizer via the first adhesive layer and the adhesion-promoting layer.

8. The polarizing plate with optical compensation function of claim 1, wherein the liquid crystal optical compensation film is used to protect the polarizer.
